(19) United States
(12) Patent Application Publication
(10) Pub. No.: US 2025/0282120 A1
(43) Pub. Date: Sep. 11, 2025

(54) FILM, WOUND BODY, CONNECTION STRUCTURE, AND METHOD FOR MANUFACTURING CONNECTION STRUCTURE

(71) Applicant: Resonac Corporation, Tokyo (JP)

(72) Inventors: Kenta KIKUCHI, Tokyo (JP); Mayumi SATO, Tokyo (JP); Yasuo MAEHARA, Tokyo (JP); Mitsuyoshi SHIMAMURA, Tokyo (JP); Hiroyuki IZAWA, Tokyo (JP)

(21) Appl. No.: 18/859,940

(22) PCT Filed: Jun. 21, 2022
(86) PCT No.: PCT/JP2022/024681

§ 371 Date: Oct. 24, 2024

(51) Int. Cl. B32B 7/06; B32B 3/26; B32B 3/30

(52) U.S. Cl. CPC B32B 7/06; B32B 3/266; B32B 3/30; B32B 2307/202; B32B 2307/7376; B32B 2405/00

(57) ABSTRACT

A film including: a long release film; a plurality of adhesive film pieces provided on the release film; and a groove formed on a surface of the release film on the side of the plurality of adhesive film pieces, extending along an outer edge of each of the plurality of adhesive film pieces, wherein the groove has a width of 15 μm or more.

### TECHNICAL FIELD

The present invention relates to a film, a wound body, a connection structure, and a method for manufacturing a connection structure.

### BACKGROUND ART

In recent years, devices such as smartphones, personal computers, earphones, smart watches, and wearable devices have become more functional, smaller, thinner, and more sophisticated in design, and the sensors, parts, and boards mounted on these devices are also becoming more functional and complex. Along with this, there are an increasing number of cases where low heat resistant materials are used for some or all of the sensors, components, boards, and the like, where low heat resistant sensors, components, boards, and the like are mounted on devices, or where other components are connected at high temperatures in close positions to low heat resistant sensors, components, boards, and the like. Furthermore, “connecting” includes the meanings of bonding, mounting, and installation. As a result, there is a demand for technology that allows connecting other components only to one or more predetermined positions on sensors, components, boards, and the like. Furthermore, the positions at which other members are connected to sensors, components, boards, and the like vary depending on the type of device and the like.

### CITATION LIST

### Patent Literature

Patent Literature 1: International Publication WO 2018/066411

### SUMMARY OF INVENTION

### Technical Problem

Therefore, it is conceivable to use a film having a plurality of adhesive film pieces provided on a release film as described in Patent Literature 1, and to attach the adhesive film pieces only to one or more predetermined positions on a sensor, component, board, and the like. As such a film, a wound body in which a film is wound on a core is generally used.

However, since the adhesive forming the adhesive film piece is not completely cured, the adhesive tends to be deformed over time to spread along the surface of the release film. Further, since the film is wound on the core by applying a certain tension to the release film, the film is in a state of being pressed toward the core (center) in the wound body. The pressure is also called a winding pressure generated by winding the film. The winding pressure increases toward the center. Therefore, the adhesive film piece sandwiched from the inner layer side (the core side) and the outer layer side (the opposite side to the core) by the release film is pressed from the inner layer side and the outer layer side by the release film, and tends to be deformed while spreading along the surface of the release film.

When the adhesive film piece is deformed to spread along the surface of the release film, the adhesive film piece may protrude from the attachment surface, which may result in poor yield. Particularly in the case of anisotropic conductive films, since the adhesive that forms the adhesive film pieces contains a liquid resin component, significant deformation of the adhesive film pieces occurs along the surface of the release film, which can further reduce yield.

Therefore, an object of an aspect of the present invention is to provide a film, a wound body, a connection structure, and a method for manufacturing a connection structure capable of suppressing spreading of an adhesive film piece.

### Solution to Problem

As a result of extensive research by the present inventors into the above-described problems, it was discovered that the spreading of the adhesive film piece can be suppressed by forming a groove on the surface of the release film piece and setting the width of the groove to a predetermined value or more. The present invention has been made based on the above findings.

That is, a film according to an aspect of the present invention includes: a long release film; a plurality of adhesive film pieces provided on the release film; and a groove formed on a surface of the release film on the side of the plurality of adhesive film pieces, extending along an outer edge of each of the plurality of adhesive film pieces, wherein the groove has a width of 15 μm or more.

In the film, since the plurality of adhesive film pieces are provided on the release film, each of the plurality of adhesive film pieces tends to spread along the surface of the release film. However, the groove is formed on the surface of the release film on the side of the plurality of adhesive film pieces, extending along the outer edge of each of the plurality of adhesive film pieces, and the width of the groove is 15 μm or more. Therefore, since the groove prevents each of the plurality of adhesive film pieces from spreading along the surface of the release film, it is possible to suppress each of the plurality of adhesive film pieces from spreading beyond the groove.

The groove may be located outside the outer edge of each of the plurality of adhesive film pieces. In the film, since the groove is located outside the outer edge of each of the plurality of adhesive film pieces, it is possible to further suppress the spreading of each of the plurality of adhesive film pieces.

The depth of the groove may be 10% or more of the thickness of the release film. In the film, since the depth of the groove is 10% or more of the thickness of the release film, the width of the groove can be easily set to 15 μm or more, and the path for each of the plurality of adhesive film pieces to pass over the groove can be lengthened. Accordingly, it is possible to further suppress each of the plurality of adhesive film pieces from spreading beyond the groove.

The depth of the groove may be 85% or less of the thickness of

the release film. In the film, since the depth of the groove is 85% or less of the thickness of the release film, the breakage of the release film can be suppressed.

The depth of the groove may be 20% or more of the thickness of the adhesive film piece surrounded by the groove among the plurality of adhesive film pieces. In the film, since the depth of the groove is 20% or more of the thickness of the adhesive film piece surrounded by the groove, it is possible to lengthen the path for each of the plurality of adhesive film pieces to pass over the groove. Accordingly, it is possible to further suppress each of the plurality of adhesive film pieces from spreading beyond the groove.

The depth of the groove may be 100% or less of the thickness of the adhesive film piece surrounded by the groove among the plurality of adhesive film pieces. In the film, since the depth of the groove is 100% or less of the thickness of the adhesive film piece surrounded by the groove, the groove can be easily formed.

The adhesive forming each of the plurality of adhesive film pieces may have a multi-layer structure. In the film, since the adhesive forming each of the plurality of adhesive film pieces has a multi-layer structure, each of the plurality of adhesive film pieces easily spreads. However, since the groove has a width of 15 μm or more as described above, it is possible to suppress each of the plurality of adhesive film pieces from spreading beyond the groove.

The curing degree in differential scanning calorimetry of the adhesive that forms each of the plurality of adhesive film pieces may be 80% or more at 150° C. for 10 seconds. In the film, since the curing degree in differential scanning calorimetry of the adhesive that forms each of the plurality of adhesive film pieces may be 80% or more at 150° C. for 10 seconds, it is possible to reduce the effect of heat on areas other than the connection points.

The plurality of adhesive film pieces may be separated from each other. In the film, since the plurality of adhesive film pieces are separated from each other, the adhesive film piece can be attached to the attachment surface without affecting the adjacent adhesive film piece. Accordingly, the adhesive film piece can be easily attached to the attachment surface.

The plurality of adhesive film pieces may be separated from the edges of the release film in the width direction of the release film. In the film, since the plurality of adhesive film pieces are separated from the edges of the release film in the width direction of the release film, it is possible to suppress the adhesive film piece from being released from the release film when the ends of the release film interfere with other members.

The plurality of adhesive film pieces may be arranged in one row in the longitudinal direction of the release film. In the film, since the plurality of adhesive film pieces are arranged in one row in the longitudinal direction of the release film, the adhesive film piece can be easily attached.

At least one of the plurality of adhesive film pieces may have a hole. In the film, since at least one of the plurality of adhesive film pieces has the hole, for example, the adhesive film piece can be appropriately attached to a portion having a center portion where the adhesive film piece is not desired to be attached.

The plurality of adhesive film pieces may have the same shape. In the film, since the plurality of adhesive film pieces have the same shape, the adhesive film pieces can be efficiently or simultaneously attached to the plurality of attachment surfaces having the same shape.

The plurality of adhesive film pieces may be conductive. In the film, since the adhesive film piece is conductive, the members connected through the adhesive film piece can be made electrically conductive.

The adhesive film piece may contain conductive particles. In the film, since the adhesive film piece contains conductive particles, the adhesive film piece can easily have conductivity.

A wound body according to an aspect of the present invention includes: any one of the above-described films; and a core on which the film is wound.

In the wound body, since any one of the above-described films is wound on the core, the film is subjected to a winding pressure that presses the film toward the core (center). Therefore, the adhesive film piece sandwiched from the inner layer side (the core side) and the outer layer side (the opposite side to the core) by the release film is pressed from the inner layer side and the outer layer side by the release film, and tends to be deformed while spreading along the surface of the release film. However, the film includes the groove formed on the surface of the release film on the side of the plurality of adhesive film pieces and extends along the outer edge of each of the plurality of adhesive film pieces, and the width of the groove is 15 μm or more. Therefore, since the groove prevents each of the plurality of adhesive film pieces from spreading along the surface of the release film, it is possible to suppress each of the plurality of adhesive film pieces from spreading beyond the groove.

A connection structure according to an aspect of the present invention includes: a first member that has a first attachment surface; a second member that has a second attachment surface; and any one of the above-described adhesive film pieces that connect the first attachment surface and the second attachment surface.

In the connection structure, since the first member and the second member are connected by any one of the above-described adhesive film pieces, it is possible to obtain the connection structure in which the adhesive film piece is suppressed from protruding from the first member and the second member.

A method for manufacturing a connection structure according to an aspect of the present invention includes: a preparation step of preparing any one of the above-described films; and a connection step of connecting the first attachment surface of the first member and the second attachment surface of the second member through the adhesive film piece of the film.

In the method for manufacturing the connection structure, since the first attachment surface of the first member and the second attachment surface of the second member are connected through the adhesive film piece of any one of the above-described films, it is possible to manufacture the connection structure in which the adhesive film piece is suppressed from protruding from the first member and the second member.

### Advantageous Effects of Invention

According to the present invention, the spreading of the adhesive film piece can be suppressed.

### BRIEF DESCRIPTION OF DRAWINGS

FIG. 1 is a plan view illustrating an example of a part of a film according to this embodiment.

FIG. 2 is a perspective view illustrating a wound body according to this embodiment.

FIG. 3 is a cross-sectional view illustrating an example of a cross-section taken along a line III-III illustrated in FIG. 1.

FIG. 4 is a cross-sectional view illustrating an example of a cross-section taken along a line III-III illustrated in FIG. 1.

FIG. 5 is a cross-sectional view illustrating another example of a cross-section taken along a line III-III illustrated in FIG. 1.

FIG. 6 is a plan view illustrating another example of a part of a film.

FIGS. 7(a), 7(b), and 7(c) are plan views illustrating another example of a part of a film.

FIG. 8 is a plan view illustrating another example of a part of a film.

FIG. 9 is a plan view illustrating another example of a part of a film.

FIG. 10 is a flowchart illustrating a method for manufacturing a film according to the embodiment.

FIGS. 11(a), 11(b), 11(c), and 11(d) are cross-sectional views illustrating a method for manufacturing a film illustrated in FIG. 1.

FIGS. 12(a), 12(b), 12(c), and 12(d) are perspective views illustrating a method for manufacturing a film illustrated in FIG. 1.

FIG. 13 is a cross-sectional view illustrating a connection structure according to this embodiment.

FIG. 14 is a flowchart illustrating a method for manufacturing a connection structure according to this embodiment.

FIG. 15 is a flowchart illustrating a connection step illustrated in FIG. 14.

FIG. 16 is a schematic process diagram illustrating a connection step illustrated in FIG. 14.

FIG. 17 is a schematic diagram of an observation surface of Example 1.

FIG. 18 is a schematic diagram of an observation surface of Example 2.

FIG. 19 is a schematic diagram of an observation surface of Example 3.

FIG. 20 is a schematic diagram of an observation surface of Example 4.

FIG. 21 is a schematic diagram of an observation surface of Comparative Example 1.

FIG. 22 is a table illustrating the observation results of Examples 1 to 4 and Comparative Example 1.

### DESCRIPTION OF EMBODIMENTS

Hereinafter, preferred embodiments of the present invention will be described in detail with reference to the drawings. Furthermore, in the drawings, the same or corresponding parts are denoted by the same reference numerals, and duplicate explanations are omitted. Further, in the drawings, the dimensional proportions and the like have been appropriately changed to make the explanation easier to understand.

### Film

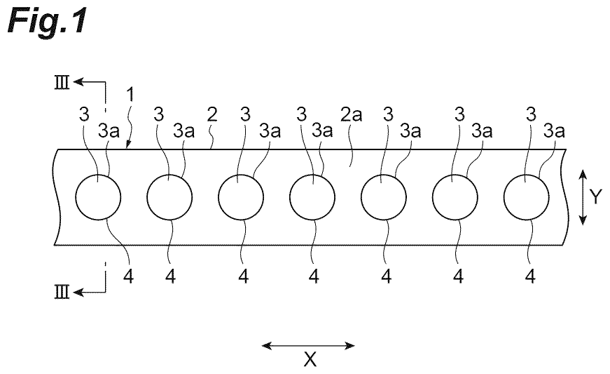

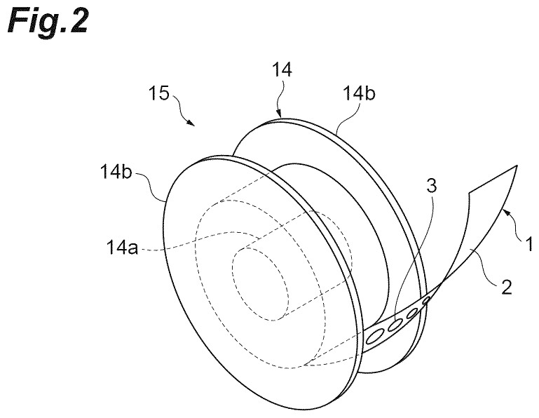

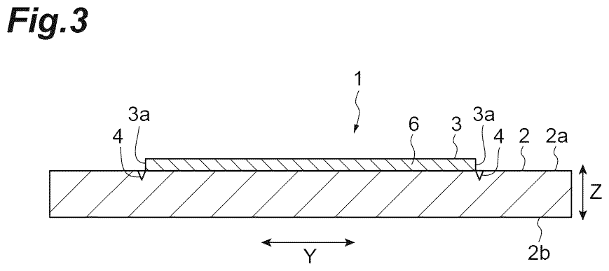

As illustrated in FIG. 1, a film 1 includes a long (tape-like) release film 2, a plurality of adhesive film pieces 3 which are provided on the release film 2, and a groove 4 (see FIGS. 3 to 5) which is formed on a surface 2a of the release film 2 on the side of the plurality of adhesive film pieces 3 and extends along an outer edge 3a of each of the plurality of adhesive film pieces 3. Furthermore, as illustrated in FIG. 2, the film 1 is stored and transported as a wound body 15 in which the film is wound on a core 14.

### Release Film

The release film 2 is attached to the plurality of adhesive film pieces 3 and supports the plurality of adhesive film pieces 3. The material of the release film 2 may be, for example, polyethylene terephthalate (PET), polyethylene, polypropylene, or the like. The release film 2 may contain any filler. Further, the surface of the release film 2 may be subjected to a release treatment, a plasma treatment, an antistatic treatment, or the like.

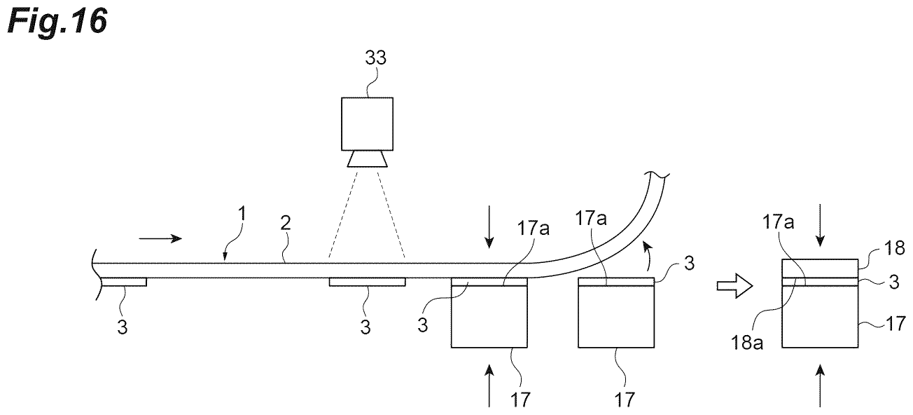

Incidentally, when attaching the adhesive film piece 3 to the attachment surface (not illustrated) of the adhesion target (not illustrated) with high accuracy, it is preferable to specify the position of the adhesive film piece 3 on the film 1. For example, the release film 2 may be provided with an alignment mark for specifying the position of the adhesive film piece 3 on the film 1, and the position of the adhesive film piece 3 may be specified based on this alignment mark. Further, the specific arrangement of the adhesive film piece 3 on the film 1 may be detected to specify the position of the adhesive film piece 3 on the film 1. Therefore, it is conceivable to detect the position of the adhesive film piece 3 on the film 1 using an image capturing device 33 (see FIG. 16). However, when it is conceived that the adhesive film piece 3 is attached to the attachment surface after that, it is preferable to place the image capturing device 33 on the opposite side of the release film 2 to the adhesive film piece 3.

Therefore, the release film 2 may be optically transparent so that the position of the adhesive film piece 3 can be detected from the side of the release film 2 by the image capturing device 33.

In this case, the transmittance of the release film 2 can be from 15% to 100%, preferably from 15% to 99%, and more preferably from 16% to 98%.

The transmittance of the release film 2 can be measured as follows. The release film cut into a 50 mm×50 mm square is placed in a haze meter (for example, NDH-5000 manufactured by NIPPON DENSHOKU INDUSTRIES CO., LTD.) and the total light transmittance is measured. Then, the measurement result is regarded as the transmittance of the release film 2.

The haze value of the release film 2 can be from 3% to 100%, preferably from 3% to 99%, and more preferably from 4% to 99%.

The haze value of the release film 2 can be measured as follows. The release film cut into a 50 mm×50 mm square is placed in a haze meter (for example, NDH-5000 manufactured by NIPPON DENSHOKU INDUSTRIES CO., LTD.) and the haze value is measured. Then, the measurement result is regarded as the haze value of the release film 2.

### Adhesive Film Piece

Each of the plurality of adhesive film pieces 3 (hereinafter, also simply referred to as “adhesive film piece 3”) connects a first member and a second member to each other. Therefore, from the viewpoint of facilitating a good connection, the adhesive film piece 3 may have the same thickness. Further, from the viewpoint of facilitating a good connection, the adhesive film piece 3 may have a flat surface. That is, the surface of the adhesive film piece 3 on the side of the release film 2 and the surface of the adhesive film piece 3 on the opposite side to the release film 2 may be flat. The same thickness means not only the completely same thickness, but also a thickness error of about ±10%. Further, the flat surface includes a completely flat surface as well as a flatness error of about ±10%. As illustrated in FIGS. 3 to 5, the adhesive film piece 3 has a film-like adhesive 6.

The adhesive 6 forming the adhesive film piece 3 can have, for example, a multi-layer structure. Examples of the multi-layer structure include a structure in which adhesive films with different components are applied in layers, a structure in which separate adhesive films are bonded together, and the like.

The adhesive 6 forming the adhesive film piece 3 may be, for example, a thermoplastic resin, a thermosetting resin, a mixture of a thermoplastic resin and a thermosetting resin, or a photocurable resin. As the thermoplastic resin, for example, a styrene resin or a polyester resin is used. As the thermosetting resin, for example, an epoxy resin, an acrylic resin, and a silicone resin are used. When using thermoplastic or thermosetting resins, heating and pressurizing are usually required. In the case of thermoplastic resins, this is to make the resin flow and obtain an adhesion force to the adhesion body, and in the case of thermosetting resins, this is to cause a curing reaction of the resin. In addition, since photocurable resins do not require heating for curing, they are useful when connections are required at low temperatures.

As the adhesive 6 forming the adhesive film piece 3, from the viewpoint of minimizing the effect of heat on parts other than the connection part, for example, a resin may be used whose curing degree in differential scanning calorimetry (DSC) is 80% or more at 150° C. for 10 seconds, 80% or more at 160° C. for 10 seconds, 80% or more at 170° C. for 10 seconds, 80% or more at 180° C. for 10 seconds, 80% or more at 200° C. for 10 seconds, 80% or more at 210° C. for 10 seconds, or 80% or more at 230° C. for 10 seconds. These resin properties can be optimized to suit the reliability level required for the final device. The curing degree in differential scanning calorimetry can be calculated from the difference in the residual heat generated by the cured resin relative to the heat generated by the uncured resin using a differential scanning calorimeter (for example, DSC Q-2500 manufactured by TA Instruments, Inc.).

The adhesive film piece 3 may be conductive or non-conductive. For example, the adhesive film piece 3 may be formed of a conductive adhesive film, a non-conductive adhesive film, or a hybrid adhesive film having conductive and non-conductive adhesive regions in the thickness direction or plane direction of the adhesive film. Further, the adhesive film piece 3 may be composed of two layers including a first adhesive layer and a second adhesive layer, or may be composed of three or more layers including a first adhesive layer, a second adhesive layer, and a third adhesive layer. The first adhesive layer, the second adhesive layer, and the third adhesive layer may be conductive or non-conductive.

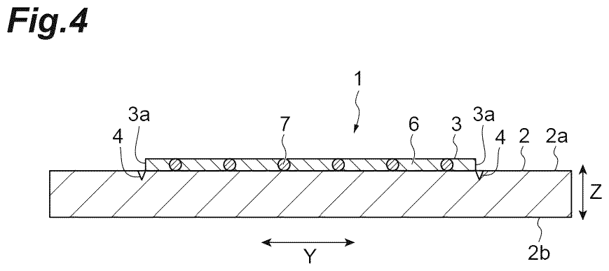

The conductive adhesive film forming the adhesive film piece 3 may have, for example, isotropic conductivity or anisotropic conductivity. For example, as illustrated in FIG. 4, by containing conductive particles 7, conductivity can be easily provided. The conductive particles 7 are contained in, for example, the adhesive 6.

The conductive particles 7 may be, for example, metal particles such as Au, Ag, Ni, Cu, Pd, solder, or carbon particles. Further, the conductive particles 7 may be formed of transition metals such as Ni and Cu, the surface of which is coated with a noble metal such as Au, Ag, or Pd. Further, the conductive particles 7 may be non-conductive particles such as glass, ceramic, or plastic with a conductive layer formed on the surface of the non-conductive particles by coating the surface of the non-conductive particles with a conductive material. The conductive particles 7 may further be those in which the outermost layer is formed of a noble metal, those using thermally fusible metal particles, or the like.

The conductive particles 7 may be conductive particles having an isotropic shape, such as a substantially spherical shape. The conductive particles having an isotropic shape refer to, for example, conductive particles having a shape that is approximately point symmetric. From the viewpoint of realizing good connection characteristics even when an oxide coating is formed on the electrode surface of the connecting member, the conductive particles 7 may be conductive particles having an anisotropic shape, such as a dendritic shape (also called a dendritic shape) or a flake shape (also called a flat plate shape or a scale shape). Conductive particles having an anisotropic shape are, for example, conductive particles having shape anisotropy, and do not have a shape that is approximately point symmetric (isotropic shape). The conductive particles 7 having an anisotropic shape can penetrate the oxide film on the electrode surface to thereby achieve good connection characteristics. The conductive particles 7 may be used alone or in combination with two or more types.

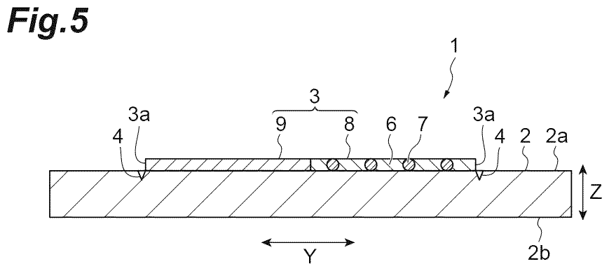

The hybrid adhesive film forming the adhesive film piece 3 may be, for example, one in which a conductive adhesive region 8 and a non-conductive adhesive region 9 are adjacently disposed on the release film 2 as illustrated in FIG. 5. The conductive adhesive region 8 may, for example, contain the conductive particles 7 similar to the conductive adhesive film.

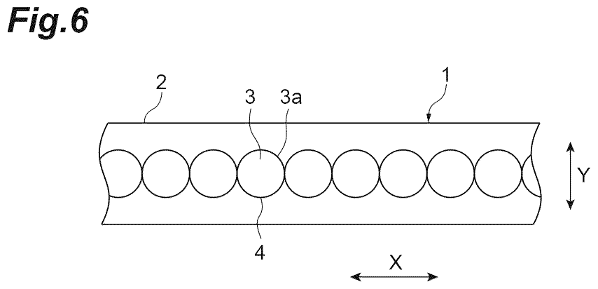

The plurality of adhesive film pieces 3 may be separated from each other in the longitudinal direction X of the release film 2 or may be connected to each other in the longitudinal direction X of the release film 2. As illustrated in FIG. 1, in this embodiment, the plurality of adhesive film pieces 3 are separated from each other in the longitudinal direction X of the release film 2. However, as in the film 1 illustrated in FIG. 6, the plurality of adhesive film pieces 3 may be connected to each other in the longitudinal direction X of the release film 2.

When the adjacent adhesive film pieces 3 are separated from each other in the longitudinal direction of the release film 2, the separation distance between the adjacent adhesive film pieces 3 in the longitudinal direction X may be 0.1 mm or more and 20 mm or less, 0.1 mm or more and 15 mm or less, 0.1 mm or more and 10 mm or less, 0.1 mm or more and 8 mm or less, or 0.2 mm or more and 5 mm or less. When the separation distance between the adjacent adhesive film pieces 3 in the longitudinal direction X is within the above-described range, the transportation distance of the film 1 can be shortened and the film 1 can be effectively used to decrease cost when the adjacent adhesive film pieces 3 are attached to another members.

The shape of the adhesive film piece 3 is not particularly limited and may be in various shapes. For example, the shape of the adhesive film piece 3 may be a circle such as a perfect circle or an ellipse, a polygon such as a triangle or a rectangle, a star, or a complex shape such as various marks. Examples of the quadrilateral include a square, a rectangle, a trapezoid, and the like.

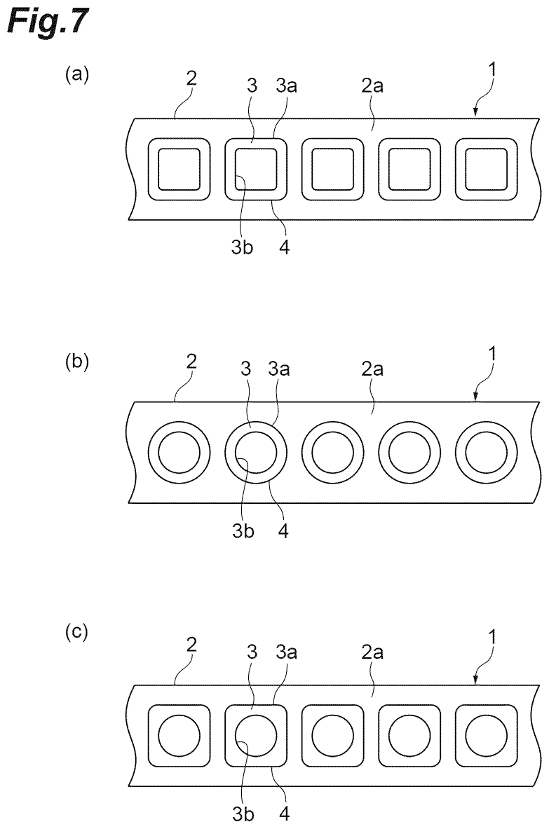

As in the film 1 illustrated in FIGS. 7(a), 7(b), and 7(c), the adhesive film piece 3 may have a hole 3b. The hole 3b is formed by hollowing out (punching out) a part of the adhesive film piece 3. The shape, size, position, number, and the like of the holes 3b are not particularly limited. For example, the hole 3b may or may not have a shape similar to that of the adhesive film piece 3. The shape of the hole 3b may be a circle such as a perfect circle or an ellipse, a polygon such as a triangle or a rectangle, a star, or a complex shape such as various marks. Examples of the quadrilateral include a square, a rectangle, a trapezoid, and the like. The hole 3b may be located in the center of the adhesive film piece 3 or at an end of the adhesive film piece 3. The number of holes 3b formed in one adhesive film piece 3 may be one or two or more. When a plurality of holes 3b are formed in one adhesive film piece 3, the shapes, sizes, and the like of the holes 3b may be the same or different. The adhesive film piece 3 illustrated in FIG. 7(a) has a rectangular outer shape, and a rectangular hole 3b similar to the outer shape of the adhesive film piece 3 is formed in the center. The adhesive film piece 3 illustrated in FIG. 7(b) has a circular outer shape, and a circular hole 3b similar to the outer shape of the adhesive film piece 3 is formed in the center. The adhesive film piece 3 illustrated in FIG. 7(c) has a rectangular outer shape, and a circular rectangular hole 3b is formed in the center.

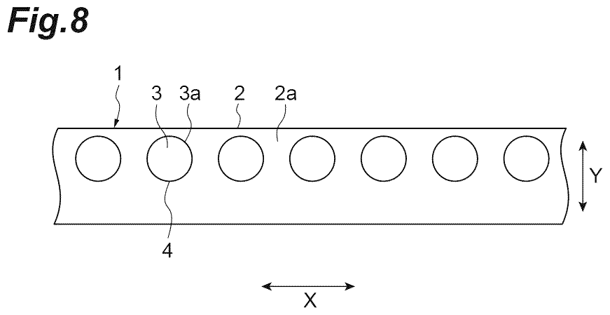

The plurality of adhesive film pieces 3 may be arranged in one row in the longitudinal direction X of the release film 2 or may be arranged in a plurality of rows in the longitudinal direction X of the release film 2. Furthermore, when the plurality of adhesive film pieces 3 are arranged in one row in the longitudinal direction X of the release film 2, only the plurality of adhesive film pieces 3 arranged in one row are provided on the release film 2. When the plurality of adhesive film pieces 3 are arranged in one row in the longitudinal direction X of the release film 2, the plurality of adhesive film pieces 3 may be arranged at the center portion of the release film 2 in the width direction Y as in the film 1 illustrated in FIG. 1 or may be arranged at a position shifted (offset) from the center of the release film 2 in the width direction Y as in the film 1 illustrated in FIG. 8.

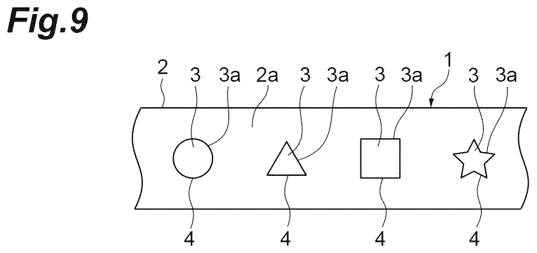

The plurality of adhesive film pieces 3 may have the same shape or may have different shapes as in the film 1 illustrated in FIG. 9. When the plurality of adhesive film pieces 3 have different shapes, all of the adhesive film pieces 3 may have different shapes or the adhesive film pieces 3 having different shapes may be mixed with the adhesive film pieces 3 having the same shape.

The plurality of adhesive film pieces 3 may be separated from the edges of the release film 2 in the width direction Y of the release film 2. In this case, the separation distance between the edge of the release film 2 and the adhesive film piece 3 closest to the edge in the width direction Y of the release film 2 can be 0.1 mm or more and 20 mm or less, may be 0.1 mm or more and 15 mm or less, may be 0.1 mm or more and 10 mm or less, may be 0.1 mm or more and 8 mm or less, and may be 0.2 mm or more and 5 mm or less.

### Groove

As illustrated in FIGS. 1 and 3 to 5, the groove 4 is formed on the surface 2a of the release film 2 on the side of the plurality of adhesive film pieces 3 and does not reach the back surface 2b on the opposite side to the plurality of adhesive film pieces 3 in the release film 2. That is, the groove 4 is recessed from the surface 2a of the release film 2 in the thickness direction Z of the film 1 orthogonal to the longitudinal direction X and the width direction Y so as not to reach the back surface 2b on the opposite side to the plurality of adhesive film pieces 3 in the release film 2. The groove 4 is also called a half-cut line.

As long as the groove 4 extends along the outer edge 3a of each of the plurality of adhesive film pieces 3, the groove may extend in a solid line shape or a broken line shape. The groove 4 extending in a solid line shape means that the groove 4 extends continuously without interruption. The groove 4 extending in a broken line shape means that the groove 4 is partially interrupted at one or more points and the groove 4 extends discontinuously. The portion where the groove 4 is partially interrupted also means a break in the groove 4. When the groove 4 extends in a broken line shape, the break in the groove 4 may be formed at a predetermined interval or may be formed at any position.

The groove 4 is formed on the surface 2a of the release film 2 to prevent each of the plurality of adhesive film pieces 3 from spreading along the surface 2a of the release film 2. Further, the width (line width) of the groove 4 is 15 μm or more. The width of the groove 4 is the width in the surface 2a of the release film 2 and is the width in the direction orthogonal to the extension direction of the groove 4. Furthermore, since the groove 4 extends along the outer edge 3a of each of the plurality of adhesive film pieces 3, the extension direction of the groove 4 differs depending on the formation position of the groove 4. Therefore, the width of the groove 4 is the width in the direction orthogonal to the extension direction of the groove 4 at the point where the groove 4 is formed. From the viewpoint of preventing each of the plurality of adhesive film pieces 3 from spreading along the surface 2a of the release film 2, the width of the groove 4 is preferably 20 μm or more. On the other hand, from the viewpoint of facilitating the formation of the groove 4, the width of the groove 4 is preferably 50 μm or less, more preferably 45 μm or less, and further preferably 40 μm or less. From these viewpoints, the width of the groove 4 is preferably 15 μm or more and 50 μm or less, more preferably 15 μm or more and 45 μm or less, and further preferably 20 μm or more and 40 μm or less.

The groove 4 may be located at a position overlapping the outer edge 3a of each of the plurality of adhesive film pieces 3 or may be located outside the outer edge 3a of each of the plurality of adhesive film pieces 3. In these cases, the groove 4 has substantially the same shape as each of the plurality of adhesive film pieces 3 in plain view of the film 1, that is, the same shape as or slightly larger than each of the plurality of adhesive film pieces 3. The plan view of the film 1 refers to a view from the plane direction of the release film 2 (the direction perpendicular to the surface 2a of the release film 2) as illustrated in FIG. 1. Furthermore, FIGS. 3 to 5 illustrate a case in which the groove 4 is located outside the outer edge 3a of each of the plurality of adhesive film pieces 3.

The depth of the groove 4 is not particularly limited and can be set as appropriate in the range that does not penetrate the release film 2. The depth of the groove 4 is the depth in the thickness direction Z of the film 1. For example, from the viewpoint of facilitating the formation of the groove 4 and lengthening the path for each of the plurality of adhesive film pieces 3 to pass over the groove 4, the depth of the groove 4 is preferably 10% or more of the thickness of the release film 2, more preferably 20% or more of the thickness of the release film 2, and further preferably 30% or more of the thickness of the release film 2. On the other hand, from the viewpoint of suppressing the breakage of the release film 2, the depth of the groove 4 is preferably 85% or less of the thickness of the release film 2, more preferably 80% or less of the thickness of the release film 2, and further preferably 75% or less of the thickness of the release film 2. From these viewpoints, the depth of the groove 4 is preferably 10% or more and 85% or less of the thickness of the release film 2, more preferably 20% or more and 80% or less of the thickness of the release film 2, and further preferably 30% or more and 75% or less of the thickness of the release film 2.

From the viewpoint of lengthening the path for each of the plurality of adhesive film pieces 3 to pass over the groove 4, the depth of the groove 4 is preferably 20% or more of the thickness of the adhesive film piece 3 surrounded by the groove 4 among the plurality of adhesive film pieces 3, more preferably 30% or more of the thickness of the adhesive film piece 3 surrounded by the groove 4 among the plurality of adhesive film pieces 3, and further preferably 40% or more of the thickness of the adhesive film piece 3 surrounded by the groove 4 among the plurality of adhesive film pieces 3. On the other hand, from the viewpoint of facilitating the formation of the groove 4, the depth of the groove 4 is preferably 100% or less of the thickness of the adhesive film piece 3 surrounded by the groove 4 among the plurality of adhesive film pieces 3, more preferably 90% or less of the thickness of the adhesive film piece 3 surrounded by the groove 4 among the plurality of adhesive film pieces 3, and further preferably 80% or less of the thickness of the adhesive film piece 3 surrounded by the groove 4 among the plurality of adhesive film pieces 3. From these viewpoints, the depth of the groove 4 is preferably 20% or more and 100% or less of the thickness of the adhesive film piece 3 surrounded by the groove 4 among the plurality of adhesive film pieces 3, more preferably 30% or more and 90% or less of the thickness of the adhesive film piece 3 surrounded by the groove 4 among the plurality of adhesive film pieces 3, and further preferably 40% or more and 80% or less of the thickness of the adhesive film piece 3 surrounded by the groove 4 among the plurality of adhesive film pieces 3. Furthermore, the thickness of the adhesive film piece 3 is the thickness of the film 1 in the thickness direction Z as in the depth of the groove 4. Further, since the groove 4 extends along the outer edge 3a of each of the plurality of adhesive film pieces 3, each of the plurality of adhesive film pieces 3 is surrounded by the groove 4. Therefore, when one adhesive film piece 3 is a target adhesive film piece and the groove 4 extending along the outer edge 3a of the target adhesive film piece is a target groove, the adhesive film piece 3 surrounded by the groove 4 among the plurality of adhesive film pieces 3 is the target adhesive film piece surrounded by the target groove.

### Film Manufacturing Method

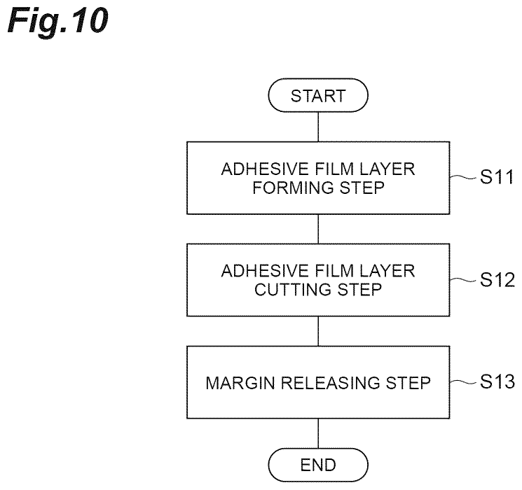

As illustrated in FIG. 10, a film manufacturing method includes, for example, an adhesive film layer forming step (S11), an adhesive film layer cutting step (S12) performed after the adhesive film layer forming step (S11), and a margin releasing step (S13) performed after the adhesive film layer cutting step (S12).

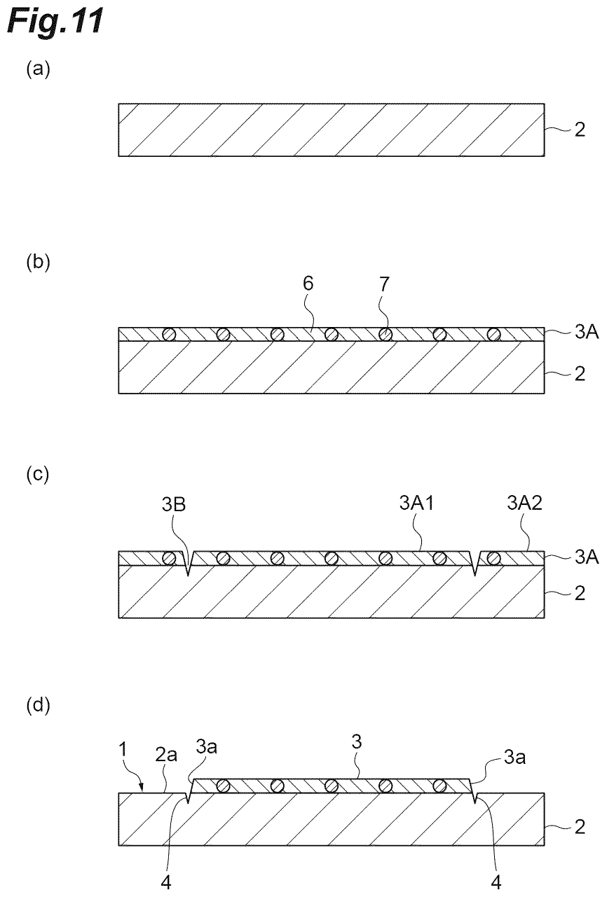

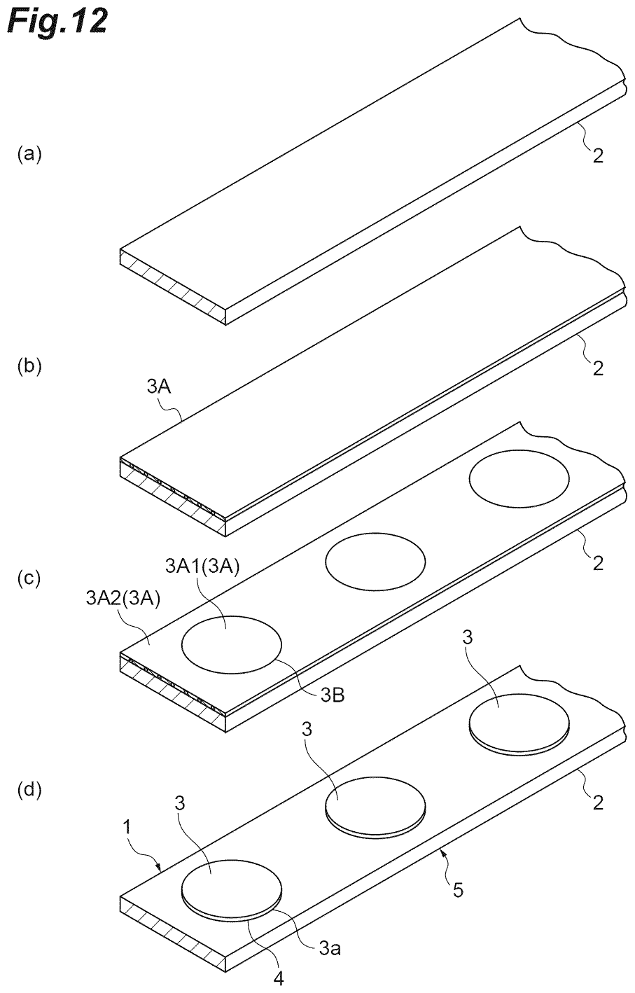

In the adhesive film layer forming step (S11), first, as illustrated in FIGS. 11(a) and 12(a), the release film 2 is prepared. Then, as illustrated in FIGS. 11(b) and 12(b), an adhesive film layer 3A is formed on the entire surface of the release film 2. The adhesive film layer 3A is a layer that will become the plurality of adhesive film pieces 3. The adhesive film layer 3A is formed by, for example, the adhesive 6 and the conductive particles 7 contained in the adhesive 6. The adhesive 6 and the conductive particles 7 forming the adhesive film layer 3A are the same as the adhesive 6 and the conductive particles 7 forming the adhesive film piece 3.

In the adhesive film layer cutting step (S12), as illustrated in FIGS. 11(c) and 12(c), the adhesive film layer 3A formed on the release film 2 is cut along an outer edge line 3B that forms the outer edges 3a of the plurality of adhesive film pieces 3 provided on the film 1, and the release film 2 is half-cut. The adhesive film layer 3A is cut and the release film 2 is half-cut, for example, by pressing the adhesive film layer 3A against a roll cutter having a cutting blade formed on the outer circumferential surface. As the cutting blade, for example, a Pinnacle blade, a Thomson blade, and the like can be used. Half-cutting the release film 2 means that the surface 2a of the release film 2 on the side of the adhesive film layer 3A is cut so that the back surface 2b of the release film 2 on the opposite side to the adhesive film layer 3A is not cut. Accordingly, a cut line is formed on the adhesive film layer 3A along the outer edge 3a of each of the plurality of adhesive film pieces 3 provided on the film 1, and a half-cut line is provided on the release film 2 along the outer edge 3a of each of the plurality of adhesive film pieces 3 provided on the film 1. At this time, the half-cutting of the release film 2 is performed so that the width of the half-cut line of the release film 2 becomes 15 μm or more. Furthermore, the width of the half-cut line of the release film 2 can be made 15 μm or more by appropriately setting the thickness of the cutting blade, the shape of the blade, the cutting depth of the cutting blade into the release film 2, and the like. Accordingly, the adhesive film layer 3A is divided into an inner portion 3A1 located inside the outer edge line 3B and a plurality of margin portions 3A2 located outside the outer edge line 3B. The inner portion 3A1 is a portion that will become the plurality of adhesive film pieces 3 provided on the film 1. The margin portion 3A2 is a portion that will become a portion other than the plurality of adhesive film pieces 3 provided on the film 1.

In the margin releasing step (S13), as illustrated in FIGS. 11(d) and 12(d), the margin portion 3A2 of the adhesive film layer 3A is released from the release film 2 along the cut outer edge line 3B. The margin portion 3A2 is released, for example, by attaching an adhesive tape to the margin portion 3A2 and pulling the adhesive tape to release the margin portion 3A2 from the release film 2. Then, the inner portion 3A1 remaining on the release film 2 becomes the plurality of adhesive film pieces 3 provided on the film 1. Accordingly, the film 1 in which the plurality of adhesive film pieces 3 are provided on the release film 2 is manufactured. Further, the half-cut line of the release film 2 becomes the groove 4 which is formed on the surface 2a of the release film 2 on the side of the plurality of adhesive film pieces 3 and extends along the outer edge 3a of each of the plurality of adhesive film pieces 3. Therefore, in the film 1 manufactured in this way, the groove 4 is formed on the surface 2a of the release film 2 on the side of the plurality of adhesive film pieces 3 and extends along the outer edge 3a of each of the plurality of adhesive film pieces 3, and the width of the groove 4 is 15 μm or more.

### Wound Body

As illustrated in FIG. 2, the wound body 15 includes the long (tape-like) film 1 and the core 14 on which the film 1 is wound. That is, the wound body 15 is formed by winding the film 1 on the core 14.

The core 14 includes a core material 14a and a pair of side plates 14b. The core material 14a is formed in a columnar shape. The film 1 is wound on the outer circumferential surface of the core material 14a. The pair of side plates 14b are attached to both ends of the core material 14a in the axial direction. The pair of side plates 14b support the film 1 from the left and right. The gap between the pair of side plates 14b is slightly wider than the width of the film 1.

### Connection Structure

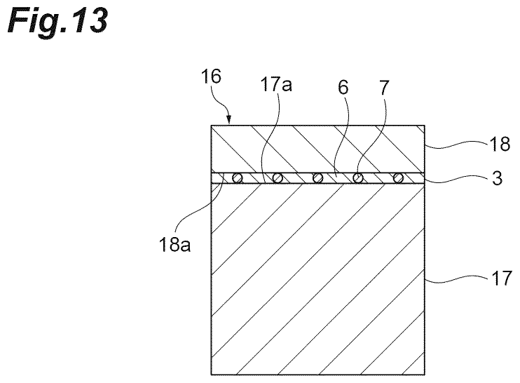

As illustrated in FIG. 13, a connection structure 16 includes a first member 17 that has a first attachment surface 17a, a second member 18 that has a second attachment surface 18a, and the adhesive film piece 3 which connects the first attachment surface 17a and the second attachment surface 18a.

The first member 17 is, for example, a chip component such as an IC chip, an LSI chip, a resistor chip, or a capacitor chip, a photoelectric conversion component such as an LED or an image sensor, a piezoelectric conversion component such as a strain sensor, a pressure sensor, an acoustic component, or a piezo element, a circuit forming component such as a flexible printed wiring board, a thermal sensor such as a thermometer or a heat sink, or a thermal management component. In the first member 17, a surface that faces the second member 18 is the first attachment surface 17a. For example, a first electrode (not illustrated) for electrical conduction with the second member 18 is disposed on the first attachment surface 17a.

The second member 18 is, for example, a substrate having optical transparency such as a glass substrate, a polyimide substrate, a polyamide-imide substrate, a polyethylene terephthalate substrate, a polycarbonate substrate, a cycloolefin polymer (COP) substrate, a polyethylene naphthalate substrate, a glass-reinforced epoxy substrate, a paper phenol substrate, a ceramic substrate, a laminated plate, or a silicon substrate. In the second member 18, a surface that faces the first attachment surface 17a of the first member 17 is the second attachment surface 18a. A second electrode (not illustrated) for electrical conduction with the first member 17 is disposed on the second attachment surface 18a.

Furthermore, there is no clear distinction between the first member 17 and the second member 18, and any member may be used for each member.

The adhesive film piece 3 is the adhesive film piece 3 which is released from the film 1. The adhesive film piece 3 connects the first attachment surface 17a and the second attachment surface 18a by the adhesive 6. When the adhesive film piece 3 has anisotropic conductivity due to the inclusion of the conductive particles 7, the conductive particles 7 can establish electrical conductivity between the first electrode on the first attachment surface 17a and the second electrode on the second attachment surface 18a.

### Method for Manufacturing Connection Structure

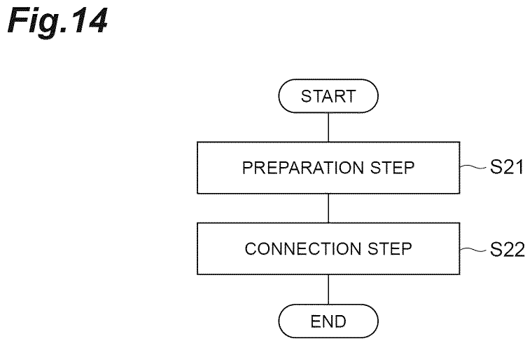

As illustrated in FIG. 14, the method for manufacturing the connection structure includes a preparation step (S21) and a connection step (S22) performed after the preparation step (S21).

In the preparation step (S21), the film 1 is prepared. At this time, the wound body 15 obtained by winding the film 1 is prepared as the film 1. Furthermore, in the preparation step (S21), the above-described film manufacturing method may be performed or only the film 1 manufactured by the above-described film manufacturing method may be prepared.

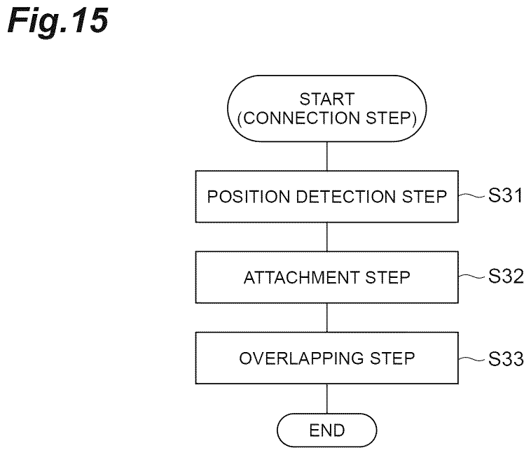

As illustrated in FIG. 15, the connection step (S22) includes a position detection step (S31), an attachment step (S32), and an overlapping step (S33).

In the position detection step (S31), first, the film 1 is unwound from the wound body 15. Then, as illustrated in FIG. 16, the position of the adhesive film piece 3 in the film 1 is detected by the image capturing device 33. At this time, the image capturing device 33 may be disposed on the side of the adhesive film piece 3 with respect to the release film 2 or may be disposed on the opposite side to the adhesive film piece 3 with respect to the release film 2. As illustrated in FIG. 16, in this embodiment, the image capturing device 33 is disposed on the opposite side to the adhesive film piece 3 with respect to the release film 2. In this case, since the release film 2 having optical transparency is used, the image capturing device 33 can detect the position of the adhesive film piece 3 in the film 1 from the side of the release film 2.

In the attachment step (S32), the adhesive film piece 3 is attached to the first attachment surface 17a based on the position detected by the position detection step (S31). Then, the release film 2 is released from the adhesive film piece 3 attached to the first attachment surface 17a. In this step, the adhesive film piece 3 can be easily released from the release film 2 by applying heat and pressure within a range that does not affect the curing degree of the adhesive of the adhesive film piece 3. For example, the heating temperature may be 70° C., the heating time may be 1 second, and the pressure against the area of the adhesive film piece 3 may be 1 MPa.

In the overlapping step (S33), the first attachment surface 17a and the second attachment surface 18a are overlapped with each other through the adhesive film piece 3. Accordingly, the first attachment surface 17a and the second attachment surface 18a are temporarily connected by the adhesive 6 of the adhesive film piece 3. Then, the first member 17 and the second member 18 are pressed together and heat or light is applied to the adhesive 6 of the adhesive film piece 3 to cure the adhesive 6. Accordingly, it is possible to obtain the connection structure 16 in which the first attachment surface 17a and the second attachment surface 18a are connected to each other by the adhesive film piece 3. When the adhesive film piece 3 has anisotropic conductivity due to the inclusion of the conductive particles 7, the first member 17 and the second member 18 are pressed together to make the first member 17 and the second member 18 to be electrically conductive by the conductive particles 7 of the adhesive film piece 3 before the adhesive 6 is cured. Accordingly, the connection structure 16 is manufactured.

In this way, in the film 1 according to this embodiment, since the plurality of adhesive film pieces 3 are provided on the release film 2, each of the plurality of adhesive film pieces 3 tends to spread along the surface 2a of the release film 2. However, the groove 4 is provided on the surface 2a of the release film 2 on the side of the plurality of adhesive film pieces 3 and extends along the outer edge 3a of each of the plurality of adhesive film pieces 3, and the width of the groove 4 is 15 μm or more. Therefore, since the groove 4 prevents each of the plurality of adhesive film pieces 3 from spreading along the surface 2a of the release film 2, it is possible to suppress each of the plurality of adhesive film pieces 3 from spreading beyond the groove 4.

Further, in the film 1, since the groove 4 is located outside the outer edge 3a of each of the plurality of adhesive film pieces 3, it is possible to further suppress the spreading of each of the plurality of adhesive film pieces 3.

Further, in the film 1, since the depth of the groove 4 is 10% or more of the thickness of the release film 2, the width of the groove 4 can be easily made 15 μm or more, and the path for each of the plurality of adhesive film pieces 3 to pass over the groove 4 can be lengthened. Accordingly, it is possible to further suppress each of the plurality of adhesive film pieces 3 from spreading beyond the groove 4.

Further, in the film 1, since the depth of the groove 4 is 85% or less of the thickness of the release film 2, it is possible to suppress the breakage of the release film 2.

Further, in the film 1, since the depth of the groove 4 is 20% or more of the thickness of the adhesive film piece 3 surrounded by the groove 4, the path for each of the plurality of adhesive film pieces 3 to pass over the groove 4 can be lengthened. Accordingly, it is possible to further suppress each of the plurality of adhesive film pieces 3 from spreading beyond the groove 4.

Further, in the film 1, since the depth of the groove 4 is 100% or less of the thickness of the adhesive film piece 3 surrounded by the groove 4, the groove 4 can be easily formed.

Further, in the film 1, since the adhesive 6 that forms each of the plurality of adhesive film pieces 3 has a multi-layer structure, each of the plurality of adhesive film pieces 3 easily spreads. However, since the groove 4 has a width of 15 μm or more as described above, it is possible to suppress each of the plurality of adhesive film pieces 3 from spreading beyond the groove 4.

Further, in the film 1, since the curing degree in differential scanning calorimetry of the adhesive 6 that forms each of the plurality of adhesive film pieces 3 is 80% or more at 150° C. for 10 seconds, 80% or more at 160° C. for 10 seconds, 80% or more at 170° C. for 10 seconds, 80% or more at 180° C. for 10 seconds, 80% or more at 200° C. for 10 seconds, 80% or more at 210° C. for 10 seconds, or 80% or more at 230° C. for 10 seconds, it is possible to reduce the effect of heat on areas other than the connection points and to appropriately suppress each of the plurality of adhesive film pieces 3 from spreading beyond the groove 4.

Further, in the film 1, since the adhesive 6 that forms each of the

plurality of adhesive film pieces 3 may be a thermoplastic resin such as a styrene resin or a polyester resin, a thermosetting resin such as an epoxy resin, an acrylic resin, or a silicone resin, a mixture of these thermoplastic resins and thermosetting resins, or a photocurable resin, it is possible to appropriately suppress each of the plurality of adhesive film pieces 3 from spreading beyond the groove 4.

Further, in the film 1, since the plurality of adhesive film pieces 3 are separated from each other, the adhesive film piece 3 can be attached to the attachment surface without affecting the adjacent adhesive film piece 3. Accordingly, the adhesive film piece 3 can be easily attached to the attachment surface.

Further, in the film 1, since the plurality of adhesive film pieces 3 are separated from the edge of the release film 2 in the width direction of the release film 2, it is possible to suppress the adhesive film piece 3 from being released from the release film 2 when the ends of the release film 2 interfere with other members.

Further, in the film 1, since the plurality of adhesive film pieces 3 are arranged in one row in the longitudinal direction X of the release film 2, the adhesive film piece 3 can be easily attached.

Further, in the film 1, since at least one of the plurality of adhesive film pieces 3 has the hole 3b, the adhesive film piece 3 can be appropriately attached to a portion having a center portion where the adhesive film piece 3 is not desired to be attached.

Further, in the film 1, since the plurality of adhesive film pieces 3 have the same shape, the adhesive film piece 3 can be efficiently attached to a plurality of attachment surfaces having the same shape.

Further, in the film 1, since the adhesive film piece 3 is conductive, two members can be made electrically conductive through the adhesive film piece 3.

Further, in the film 1, since the adhesive film piece 3 contains the conductive particles 7, the adhesive film piece 3 can be easily made conductive.

In the wound body 15 according to this embodiment, since the film 1 is wound on the core 14, the film 1 is subjected to a winding pressure that presses the film toward the core material 14a (center) of the core 14. Therefore, the adhesive film piece 3 sandwiched from the inner layer side (the core side) and the outer layer side (the opposite side to the core) by the release film 2 is pressed from the inner layer side and the outer layer side by the release film 2, and tends to be deformed while spreading along the surface 2a of the release film 2. However, the film 1 includes the groove 4 which is formed on the surface 2a of the release film 2 on the side of the plurality of adhesive film pieces 3 and extends along the outer edges 3a of the plurality of adhesive film pieces 3, and the width of the groove 4 is 15 μm or more. Therefore, since the groove 4 prevents each of the plurality of adhesive film pieces 3 from spreading along the surface 2a of the release film 2, it is possible to suppress each of the plurality of adhesive film pieces 3 from spreading beyond the groove 4.

In the connection structure 16 according to this embodiment, since the first member 17 and the second member 18 are connected by the adhesive film piece 3, it is possible to obtain the connection structure 16 in which the adhesive film piece 3 is suppressed from protruding from the first member 17 and the second member 18.

In the method for manufacturing the connection structure according to this embodiment, since the first attachment surface 17a of the first member 17 and the second attachment surface 18a of the second member 18 are connected through the adhesive film piece 3 of the film 1, it is possible to manufacture the connection structure 16 in which the adhesive film piece 3 is suppressed from protruding from the first member 17 and the second member 18.

The present invention is not limited to the above-described embodiment, and can be modified as appropriate without departing from the spirit of the present invention.

For example, in the above-described embodiment, an example of the connection step in the method for manufacturing the connection structure has been described, but the connection step may be realized by any method as long as it is possible to use the film and connect the first member and the second member with the adhesive film piece of the film.

Further, for example, in the above-described embodiment, the film has been described as a two-layer structure in which the plurality of adhesive film pieces are provided on the release film, but may be a three-layer structure in which the second release film is further provided on the plurality of adhesive film pieces.

All or part of the above-described examples can be expressed by [1] to [18] described below, but are not limited to the following descriptions.
[1] A film including:
a long release film;
a plurality of adhesive film pieces provided on the release film; and
a groove formed on a surface of the release film on the side of the plurality of adhesive film pieces, extending along an outer edge of each of the plurality of adhesive film pieces,
wherein the groove has a width of 15 μm or more.
[2] The film according to [1],
wherein the groove is located outside the outer edge of each of the plurality of adhesive film pieces.
[3] The film according to [1] or [2],
wherein the depth of the groove is 10% or more of the thickness of the release film.
[4] The film according to any one of [1] to [3],
wherein the depth of the groove is 85% or less of the thickness of the release film.
[5] The film according to any one of [1] to [4],
wherein the depth of the groove is 20% or more of the thickness of the adhesive film piece surrounded by the groove among the plurality of adhesive film pieces.
[6] The film according to any one of [1] to [5],
wherein the depth of the groove is 100% or less of the thickness of the adhesive film piece surrounded by the groove among the plurality of adhesive film pieces.
[7] The film according to any one of [1] to [6],
wherein an adhesive forming each of the plurality of adhesive film pieces has a multi-layer structure.
[8] The film according to any one of [1] to [7],
wherein a curing degree in differential scanning calorimetry of an adhesive forming each of the plurality of adhesive film pieces is 80% or more at 150° C. for 10 seconds.
[9] The film according to any one of [1] to [8],
wherein the plurality of adhesive film pieces are separated from each other.
[10] The film according to any one of [1] to [9],
wherein the plurality of adhesive film pieces are separated from an edge of the release film in a width direction of the release film.
[11] The film according to any one of [1] to [10],
wherein the plurality of adhesive film pieces are arranged in one row in a longitudinal direction of the release film.
[12] The film according to any one of [1] to [11],
wherein at least one of the plurality of adhesive film pieces has a hole.
[13] The film according to any one of [1] to [12],
wherein the plurality of adhesive film pieces have the same shape.
[14] The film according to any one of [1] to [13],
wherein the adhesive film piece is conductive.
[15] The film according to [14],
wherein the adhesive film piece contains conductive particles.
[16] A wound body including:
the film according to any one of [1] to [15]; and
a core on which the film is wound.
[17] A connection structure including:
a first member that has a first attachment surface;
a second member that has a second attachment surface; and
the adhesive film piece according to any one of [1] to [15] connecting the first attachment surface and the second attachment surface.
[18] A method for manufacturing a connection structure including:
a preparation step of preparing the film according to any one of [1] to [15]; and
a connection step of connecting a first attachment surface of a first member and a second attachment surface of a second member through the adhesive film piece of the film.

### EXAMPLES

Next, examples of the present invention will be described. However, the present invention is not limited to the following examples.

### Example 1

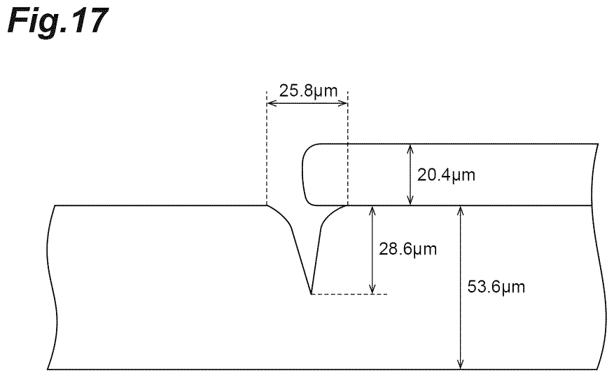

An adhesive film layer containing an adhesive and conductive particles was formed on an entire surface of a long release film. Next, the adhesive film layer formed on the release film was cut along outer edge lines that constitute outer edges of a plurality of adhesive film pieces provided on the film by a roll cutter having a pinnacle blade formed on an outer circumferential surface, and the release film was half-cut. Next, a margin portion of the adhesive film layer other than the adhesive film pieces provided on the film was released from the release film along the cut outline. Accordingly, a film of Example 1 was obtained in which the plurality of adhesive film pieces were formed on the release film and grooves were formed on the surface of the release film on the side of the plurality of adhesive film pieces and extend along the outer edges of the plurality of adhesive film pieces. Then, the film of Example 1 was wound on a core with a tension of 1.5 N to prepare a wound body, the film was unwound from the wound body, the film was cut at any position, and the cut surface was used as an observation surface and imaged with a scanning electron microscope. The S8020 manufactured by Hitachi High-Tech Corporation was used as the scanning electron microscope. A schematic diagram of the captured image is illustrated in FIG. 17.

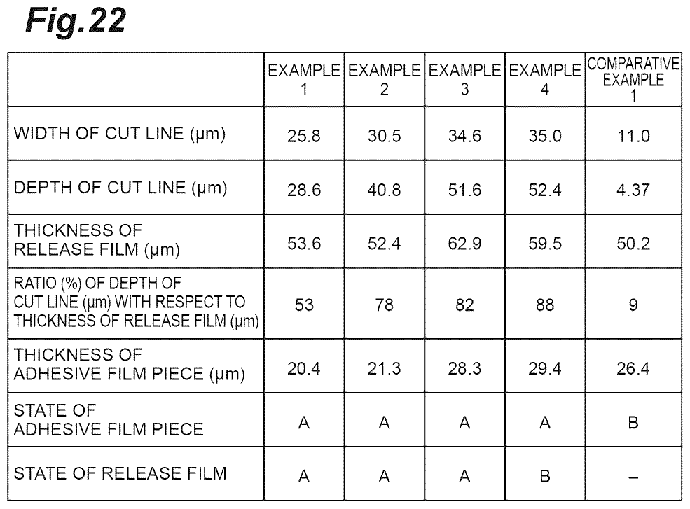

As illustrated in FIG. 17, in the observation surface, the width of the groove was 25.8 μm, the depth of the groove was 28.6 μm, the thickness of the release film was 53.6 μm, the ratio of the depth of the groove with respect to the thickness of the release film was 53%, and the thickness of the adhesive film piece was 20.4 μm. Then, the state of the adhesive film piece and the release film in the film of Example 1 was observed. In observing the state of the adhesive film piece, a case where the adhesive film piece did not spread beyond the groove was rated as A, and a case where the adhesive film piece spread beyond the groove was rated as B. In observing the state of the release film, a case where the release film was not broken was rated as A, and a case where the release film was broken was rated as B. The result is illustrated in FIG. 22.

### Example 2

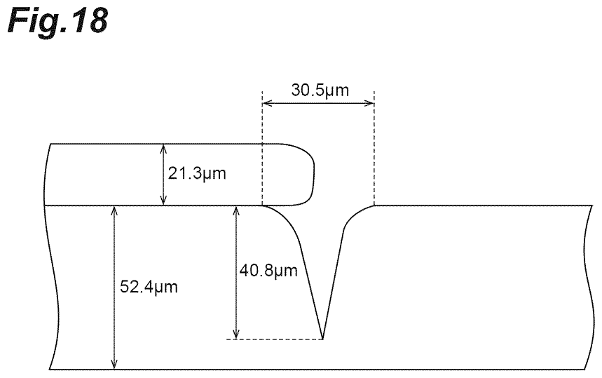

A film of Example 2 was obtained in the same manner as that of Example 1. Further, in the same manner as that of Example 1, the film of Example 2 was wound on a core to prepare a wound body, the film was unwound from the wound body, the film was cut at any position, and the cut surface was used as an observation surface and imaged with a scanning electron microscope. A schematic diagram of the captured image is illustrated in FIG. 18.

As illustrated in FIG. 18, in the observation surface, the width of the groove was 30.5 μm, the depth of the groove was 40.8 μm, the thickness of the release film was 52.4 μm, the ratio of the depth of the groove with respect to the thickness of the release film was 78%, and the thickness of the adhesive film piece was 21.3 μm. Then, as in Example 1, the state of the adhesive film piece and the release film in the film of Example 2 was observed. The result is illustrated in FIG. 22.

### Example 3

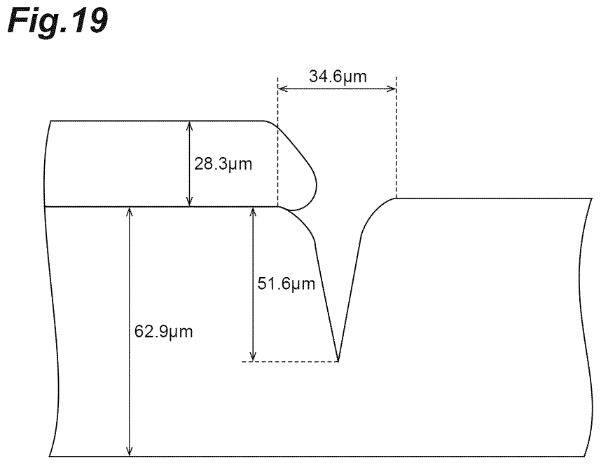

A film of Example 3 was obtained in the same manner as that of Example 1. Further, in the same manner as that of Example 1, the film of Example 3 was wound on a core to prepare a wound body, the film was unwound from the wound body, the film was cut at any position, and the cut surface was used as an observation surface and imaged with a scanning electron microscope. A schematic diagram of the captured image is illustrated in FIG. 19.

As illustrated in FIG. 19, in the observation surface, the width of the groove was 34.6 μm, the depth of the groove was 51.6 μm, the thickness of the release film was 62.9 μm, the ratio of the depth of the groove with respect to the thickness of the release film was 82%, and the thickness of the adhesive film piece was 28.3 μm. Then, as in Example 1, the state of the adhesive film piece and the release film in the film of Example 3 was observed. The result is illustrated in FIG. 22.

### Example 4

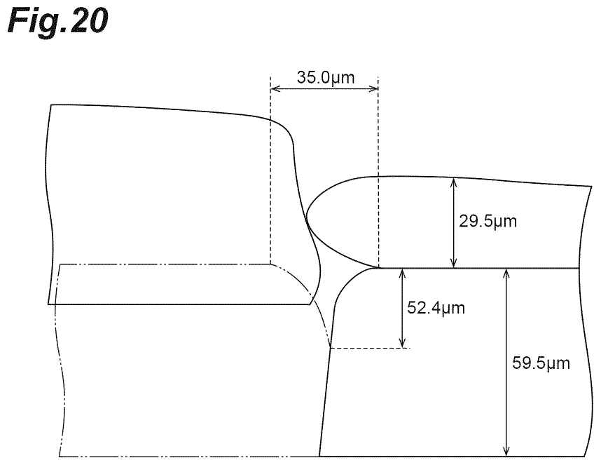

A film of Example 4 was obtained in the same manner as that of Example 1. Further, in the same manner as that of Example 1, the film of Example 4 was wound on a core to prepare a wound body, the film was unwound from the wound body, the film was cut at any position, and the cut surface was used as an observation surface and imaged with a scanning electron microscope. A schematic diagram of the captured image is illustrated in FIG. 20.

As illustrated in FIG. 20, in the observation surface, the width of the groove was 35.0 μm, the depth of the groove was 52.4 μm, the thickness of the release film was 59.5 μm, the ratio of the depth of the groove with respect to the thickness of the release film was 88%, and the thickness of the adhesive film piece was 29.4 μm. Then, as in Example 1, the state of the adhesive film piece and the release film in the film of Example 4 was observed. The result is illustrated in FIG. 22.

### Comparative Example 1

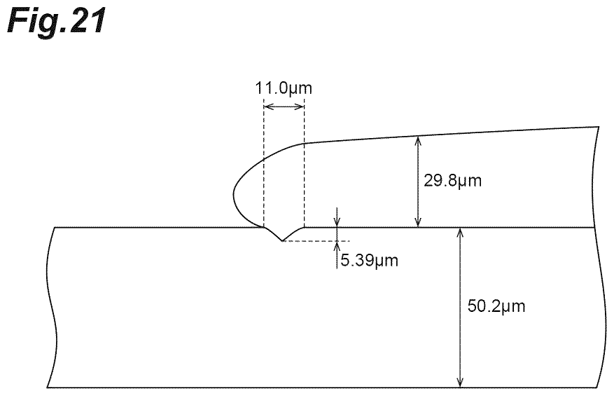

A film of Comparative Example 1 was obtained in the same manner as that of Example 1. Further, in the same manner as that of Example 1, the film of Comparative Example 1 was wound on a core to prepare a wound body, the film was unwound from the wound body, the film was cut at any position, and the cut surface was used as an observation surface and imaged with a scanning electron microscope. A schematic diagram of the captured image is illustrated in FIG. 21.

As illustrated in FIG. 21, in the observation surface, the width of the groove was 11.0 μm, the depth of the groove was 4.37 μm, the thickness of the release film was 50.2 μm, the ratio of the depth of the groove with respect to the thickness of the release film was 9%, and the thickness of the adhesive film piece was 26.4 μm. Then, as in Example 1, the state of the adhesive film piece in the film of Comparative Example 1 was observed. The result is illustrated in FIG. 22.

### Consideration

As illustrated in FIG. 22, in Comparative Example 1 in which the width of the groove was less than 15 μm, the adhesive film pieces spread beyond the groove, but in Examples 1 to 4 in which the width of the groove was 15 μm or more, the adhesive film pieces did not spread beyond the groove. Therefore, it is presumed that the adhesive film pieces are suppressed from spreading beyond the groove by setting the width of the groove to 15 μm or more.

Further, in Example 4 in which the ratio of the depth of the groove with respect to the thickness of the release film was more than 85%, the release film was broken, but in Examples 1 to 3 in which the ratio of the depth of the groove with respect to the thickness of the release film was 85% or less, the release film was not broken. Therefore, it is presumed that the breakage of the release film can be suppressed by setting the ratio of the depth of the groove with respect to the thickness of the release film to 85% or less.

### INDUSTRIAL APPLICABILITY

The present invention can be used as, for example, the film, the wound body, the connection structure, and the method for manufacturing the connection structure.

### REFERENCE SIGNS LIST

1: film, 2: release film, 2a: surface, 2b: back surface, 3: adhesive film piece, 3a: outer edge, 3A: adhesive film layer, 3A1: inner portion, 3A2: margin portion, 3b: hole, 3B: outer edge line, 4: groove, 6: adhesive, 7: conductive particles, 8: conductive adhesive region, 9: non-conductive adhesive region, 14: core, 14a: core material, 14b: side plate, 15: wound body, 16: connection structure, 17: first member, 17a: first attachment surface, 18: second member, 18a: second attachment surface, 33: image capturing device, X: longitudinal direction, Y: width direction, Z: thickness direction.

1. A film comprising:
a long release film;
a plurality of adhesive film pieces provided on the release film; and
a groove formed on a surface of the release film on the side of the plurality of adhesive film pieces, extending along an outer edge of each of the plurality of adhesive film pieces,
wherein the groove has a width of 15 μm or more.

2. The film according to claim 1,
wherein the groove is located outside the outer edge of each of the plurality of adhesive film pieces.

3. The film according to claim 1,
wherein the depth of the groove is 10% or more of the thickness of the release film.

4. The film according to claim 3,
wherein the depth of the groove is 85% or less of the thickness of the release film.

5. The film according to claim 1,
wherein the depth of the groove is 20% or more of the thickness of the adhesive film piece surrounded by the groove among the plurality of adhesive film pieces.

6. The film according to claim 5,
wherein the depth of the groove is 100% or less of the thickness of the adhesive film piece surrounded by the groove among the plurality of adhesive film pieces.

7. The film according to claim 1,
wherein an adhesive forming each of the plurality of adhesive film pieces has a multi-layer structure.

8. The film according to claim 1,
wherein a curing degree in differential scanning calorimetry of an adhesive forming each of the plurality of adhesive film pieces is 80% or more at 150° C. for 10 seconds.

9. The film according to claim 1,
wherein the plurality of adhesive film pieces are separated from each other.

10. The film according to claim 1,
wherein the plurality of adhesive film pieces are separated from an edge of the release film in a width direction of the release film.

11. The film according to claim 1,
wherein the plurality of adhesive film pieces are arranged in one row in a longitudinal direction of the release film.

12. The film according to claim 1,
wherein at least one of the plurality of adhesive film pieces has a hole.

13. The film according to claim 1,
wherein the plurality of adhesive film pieces have the same shape.

14. The film according to claim 1,
wherein the adhesive film piece is conductive.

15. The film according to claim 14,
wherein the adhesive film piece contains conductive particles.

16. A wound body comprising:
the film according to claim 1; and
a core on which the film is wound.

17. A connection structure comprising:
a first member that has a first attachment surface;
a second member that has a second attachment surface; and
the adhesive film piece according to claim 1 connecting the first attachment surface and the second attachment surface.

18. A method for manufacturing a connection structure comprising:
a preparation step of preparing the film according to claim 1; and
a connection step of connecting a first attachment surface of a first member and a second attachment surface of a second member through the adhesive film piece of the film.
